(19) United States
(12) Patent Application Publication
(10) Pub. No.: US 2020/0363991 A1
(43) Pub. Date: Nov. 19, 2020

(54) APPARATUS AND METHOD FOR SHARING A DATA ATTRIBUTE FROM A MEMORY SYSTEM, A DATA PROCESSING SYSTEM OR A NETWORK SERVER

(71) Applicant: SK hynix Inc., Gyeonggi-do (KR)

(72) Inventor: Seok-Jun LEE, Seoul (KR)

(21) Appl. No.: 16/720,683

(22) Filed: Dec. 19, 2019

(30) Foreign Application Priority Data
May 15, 2019 (KR) 10-2019-0056863

(51) Int. Cl. G06F 3/06; G06F 12/10

(52) U.S. Cl. CPC G06F 3/0659; G06F 3/0604; G06F 2212/1041; G06F 3/0673; G06F 12/10; G06F 3/0653

(57) ABSTRACT

A memory system includes a memory device including a plurality of memory blocks, and a controller configured to determine a data attribute regarding a piece of data stored in a memory block among the plurality of memory blocks, associate the data attribute with a logical address for the piece of data, and transmit the data attribute associated with the logical address to an external device.

### CROSS-REFERENCE TO RELATED APPLICATIONS

This patent application claims priority under 35 U.S.C. § 119(a) to Korean Patent Application No. 10-2019-0056863, filed on May 15, 2019, the entire disclosure of which is incorporated herein by reference.

### TECHNICAL FIELD

Various embodiments generally relate to a memory system or a data processing system, and more particularly, to a method and an apparatus for sharing a data attribute stored in the memory system with another device.

### BACKGROUND

Recently, a paradigm for a computing environment has shifted to ubiquitous computing, which enables computer systems to be accessed anytime and everywhere. As a result, the use of portable electronic devices, such as mobile phones, digital cameras, notebook computers and the like, are rapidly increasing. Such portable electronic devices typically use or include a memory system that uses at least one memory device, i.e., a data storage device. The data storage device can be used as a main storage device or an auxiliary storage device of a portable electronic device.

A data storage device using a nonvolatile semiconductor memory device is advantageous over a hard disk, in that it has excellent stability and durability because it has no mechanical driving part (e.g., a mechanical arm) and, also, has high data access speed and low power consumption. In the context of a memory system having such advantages, an exemplary data storage device may include, for example, a universal serial bus (USB) memory device, a memory card having various interfaces, or a solid-state drive (SSD).

### BRIEF DESCRIPTION OF THE DRAWINGS

The description herein makes reference to the accompanying drawings wherein like reference numerals refer to like parts throughout the figures, and wherein:

FIG. 1 illustrates a memory system according to an embodiment of the disclosure;

FIG. 2 illustrates a data processing system including a memory system according to an embodiment of the disclosure;

FIG. 3 illustrates a controller configuration in a memory system according to an embodiment of the disclosure;

FIG. 4 illustrates an example of a data structure which is used for determining a data attribute in a memory system according to an embodiment of the disclosure;

FIG. 5 illustrates a host configuration according to an embodiment of the disclosure;

FIG. 6 illustrates an example of a data structure which is used for classifying a data attribute in a host according to an embodiment of the disclosure;

FIG. 7 illustrates a method of transmitting and receiving a data attribute between a network server, a host, and a memory system according to an embodiment of the disclosure;

FIG. 8 illustrates a memory system according to an embodiment of the disclosure;

FIG. 9 illustrates a network server according to an embodiment of the disclosure;

FIG. 10 illustrates an example of a data structure which is used for classifying a data attribute in a network server according to an embodiment of the disclosure;

FIG. 11 is a flowchart illustrating a method of operating a host in a data processing system in accordance with an embodiment of the disclosure;

FIG. 12 is a flowchart illustrating a method of operating a memory system in a data processing system according to an embodiment of the disclosure; and

FIG. 13 is a flowchart illustrating a method for operating a network server according to an embodiment of the disclosure.

### DETAILED DESCRIPTION

Various embodiments of the disclosure are described below in reference to the accompanying drawings. Elements and features of the disclosure, however, may be configured or arranged differently to form other embodiments, which may be variations of any of the disclosed embodiments. Thus, the present teachings are not limited to the embodiments set forth herein. Rather, the described embodiments are provided so that this disclosure is thorough and complete and fully conveys the scope of the disclosure to those skilled in the art to which the present teachings pertain. It is noted that reference to “an embodiment,” “another embodiment” or the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance could also be termed a second or third element in another instance without departing from the spirit and scope of the present teachings.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via an intervening element therebetween. In addition, it will also be understood that when an element is referred to as being “between” two elements, it may be the only element between the two elements, or one or more intervening elements may also be present.

The terminology used herein is for the purpose of describing particular embodiments only and is not intended to be limiting. As used herein, singular forms are intended to include the plural forms, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art. It will be further understood that terms, such as those defined in commonly used dictionaries, should be interpreted as having a meaning that is consistent with their meaning in the context of the disclosure and the relevant art, and not be interpreted in an idealized or overly formal sense unless expressly so defined herein.

In the following description, numerous specific details are set forth in order to provide a thorough understanding of the disclosure. The teachings disclosed herein may be practiced without some or all of these specific details. In other instances, well-known process structures and/or processes have not been described in detail in order not to unnecessarily obscure the teachings disclosed herein.

It is also noted, that in some instances, as would be apparent to those skilled in the relevant art, a feature or element described in connection with one embodiment may be used singly or in combination with other features or elements of another embodiment, unless otherwise specifically indicated.

An embodiment of the disclosure may provide a memory system, a data processing system, and an operation process or a method, which may quickly and reliably process data into a memory device by reducing operational complexity and performance degradation of the memory system, and which may enhance usage efficiency of the memory device.

An embodiment of the disclosure may provide a method and an apparatus for determining a data attribute stored in a memory system and delivering the data attribute into a host or a network server, so that the host or the network server may transmit information regarding the data attribute into another memory system where the data is stored, and the data attribute may be shared with another device. The disclosure may provide a method and apparatus for reducing resources required to determine a data attribute and improve or enhance performance of a memory system.

An embodiment of the disclosure may provide an apparatus and a method for determining a data attribute (e.g., hot/cold) regarding data stored in a plurality of memory blocks in a memory system, associating the data attribute (e.g., hot/cold) with a logical address of the data, and transmitting the data attribute associated with the logical address to a host.

An embodiment of the disclosure may provide an apparatus and a method for collecting data attributes generated or stored through an application installed in a host or a computing device that may store or reads a piece of data in or from the memory system, and transmitting collected attributes into a network server which may distribute the attributes through updated data of the application.

An embodiment of the disclosure may provide a method and an apparatus for distributing an attribute corresponding to a piece of data generated or utilized by an application to another electronic device or a terminal after collecting the attribute regarding the piece of data from a host or a computing device in which the application is installed.

In an embodiment, a memory system may include a memory device including a plurality of memory blocks and a controller configured to determine a data attribute regarding a piece of data stored in a memory block among the plurality of memory blocks, associate the data attribute with a logical address for the piece of data, and transmit the data attribute associated with the logical address to an external device.

The data attribute may be determined based on a frequency of accessing the piece of data during a set period after the piece of data is stored in the memory device. For example, the data attribute may be determined as one of a hot attribute and a cold attribute. In another example, the data attribute may be determined as one of a hot attribute, a warm attribute and a cold attribute

The data attribute may be determined based on a frequency of accessing the piece of data during a set period after an external command is inputted from the external device.

The controller may be configured to count the number of read, write, and erase operations corresponding to the logical address and determine the data attribute based on the counted number.

The controller may be configured to determine that the data attribute is hot when the counted number is equal to or greater than a reference value, and the data attribute is cold when the counted number is less than the reference value.

The controller may be configured to receive a command for inquiring the data attribute associated with the logical address, from the external device, and transmit, to the external device, the data attribute in response to the command.

The controller may be configured to generate a piece of meta data including the logical address from the external device, a physical address associated with the logical address, and an access count indicating the number of read, write, and erase operations performed with the logical address.

In another embodiment, a memory system may include a memory device including a plurality of memory blocks allocated based on a type of data attribute; and a controller configured to store a piece of data in a memory block among the plurality of memory blocks based on a data attribute for the piece of data, when a command entered from an external device includes the piece of data, a logical address for the piece of data, and a data attribute for the piece of data.

The controller may be configured to determine the data attribute and transmit the data attribute to the external device, when the command does not include the data attribute for the piece of data.

The controller may be configured to determine the data attribute based on an access count indicating the number of read, write, and erase operations performed with the logical address.

The controller may be configured to receive a command for inquiring the data attribute corresponding to the logical address, which is inputted from the external device, and transmit the data attribute in response to the command.

In another embodiment, a method for operating a memory system may include receiving a program request, a piece of data, a logical address and a data attribute regarding the piece of data from an external device; determining a physical location for storing the piece of data in a memory block in a memory device of the memory system, the physical location being allocated based on the data attribute; programming the piece of data in the physical location; and associating the logical address with the physical location.

The method may further include receiving a command for inquiring the data attribute corresponding to the logical address, which is inputted from the external device; and transmitting, to the external device, the data attribute in response to the command.

By way of example but not limitation, the data attribute may be determined based on a frequency of accessing the piece of data during a set period after the piece of data is stored in the memory device. The data attribute is determined as one of a hot attribute and a cold attribute.

The data attribute may be determined based on a frequency of accessing the piece of data during a set period after an external command is inputted from the external device.

The method may further include counting the number of read, write, and erase operations corresponding to the logical address; and determining the data attribute based on the counted number.

The data attribute may be hot when the counted number is equal to or greater than a reference value, and the data attribute may be cold when the counted number is less than the reference value.

The method may further include generating a piece of meta data including the logical address inputted from the external device, a physical address associated with the logical address, and an access count indicating the number of read, write, and erase operations performed with the logical address.

In another embodiment, a data processing system may include a host executing an application; and a memory system receiving a piece of data from the host and storing the piece of data in a memory device. The host and the memory system may be individually configured to associate a data attribute for the piece of data with a logical address, and to transmit or receive the data attribute to or from each other. The host may be configured to transmit the data attribute via a network on an application basis.

The data attribute may be determined based on a frequency of accessing the piece of data during a set period after the piece of data is stored in the memory device. The data attribute may be determined as one of a hot attribute and a cold attribute. The data attribute may be determined based on a frequency of accessing the piece of data during a set period after an external command is inputted from the external device.

The host may be configured to classify the data attribute corresponding to the logical address, which is inputted from the memory system, and associate the data attribute with a data structure designed for the application.

The data structure may include a storage space on the memory system, which is allocated for the application. The storage space may be divided into a plurality of units by a size corresponding to a logical address.

In another embodiment, a network server may include a storage configured to store multiple pieces of data constituting an application; and a transceiver configured to receive a request regarding the application from a data processing system via a network, and transmit the multiple pieces of data to the data processing system via the network. The multiple pieces of data may be transmitted with data attributes associated with the multiple pieces of data into the data processing system.

The transceiver may be configured to transmit a request for collecting the data attributes associated with the multiple pieces of data included in the application into other data processing systems.

The network server may further include a core logic configured to estimate an average of the data attributes collected from the other data processing systems via the transceiver, associate averaged data attributes with the application, and store the averaged data attributes along with the application in the storage.

By way of example but not limitation, each data attribute is determined based on a frequency of accessing the piece of data stored in a memory system of the data processing system during a set period after the piece of data is stored in the memory system. The data attribute is determined as one of a hot attribute and a cold attribute. Each data attribute is determined based on a frequency of accessing the piece of data stored in a memory device of the data processing system during a set period after an external command is inputted from a host in the data processing system.

In another embodiment, a system can include a server; and first and second data processing system, each including a host and a memory system including a memory device, which includes a plurality of memory blocks. The first data processing system receiving an application including multiple files from the server may store the application in a first memory system, monitor data attribute of each file and transmit attribute information regarding the data attribute to the server. The server can receive the attribute information and generates the attribute information for the application. The second data processing system can receive the application and the attribute information from the server and may store the application in a second memory system based on the attribute information such that the multiple files are classified and stored in corresponding memory blocks of the second memory system.

Various embodiments of the disclosure will now be described with reference to the accompanying drawings, wherein like numbers reference like elements.

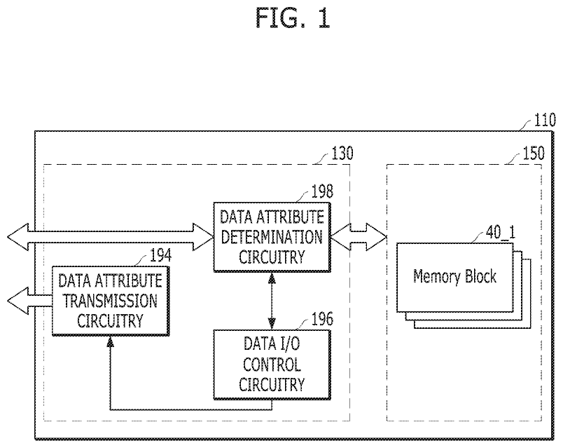

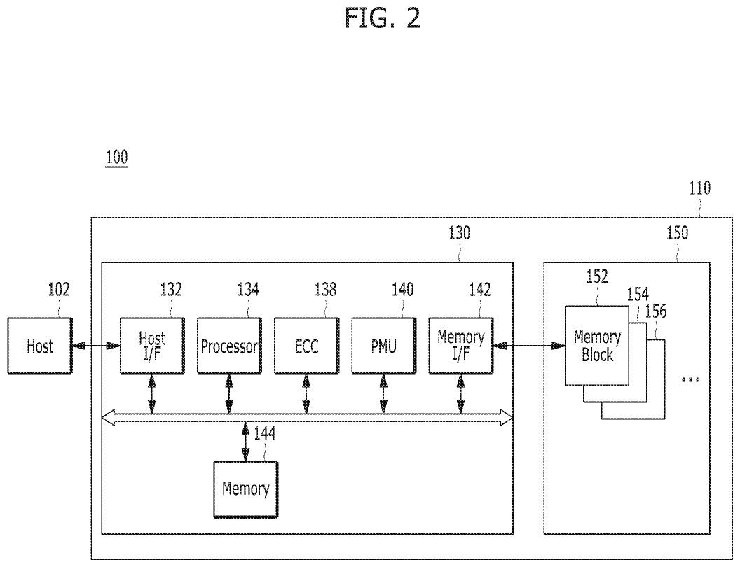

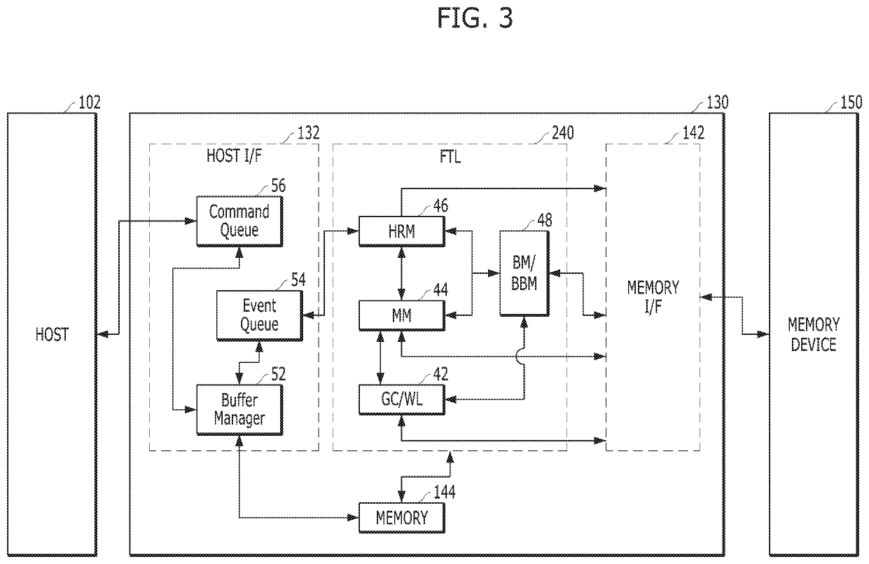

FIG. 1 illustrates a memory system 110 according to an embodiment of the disclosure. In some embodiments, the memory system 110 may be mounted on a computing device or a mobile device and transmit or receive a piece of data, a command, an instruction or a response to or from a host 102 (see FIGS. 2 and 3) which is operatively engaged with the memory system 110.

Referring to FIG. 1, the memory system 110 may include a controller 130 and a memory device 150. The controller 130 may output a piece of data delivered from the memory device 150 as a request of the host 102, or may store a piece of data transferred from the host 102 in the memory device 150. The memory device 150 may include a plurality of memory blocks, each including a plurality cells capable of storing data. The cells may be organized in pages, each page including a plurality of cells. Herein, the internal configuration of the memory device 150 may be changed depending on the characteristics of the memory device 150, the purpose for which the memory system 110 is used, or a specification of the memory system 110 required by the host 102.

The memory device 150 may include a nonvolatile memory cell. The nonvolatile memory cell may store 1-bit or more bit data even when power is not provided, i.e., turned off. After programing the nonvolatile memory cell with the data, the controller 130 may not overwrite the nonvolatile memory cell with another data without erasing the data programmed therein. By way of example but not limitation, a plurality cells of the memory block may be erased together by an erase operation. A plurality of cells of a single page may be programmed together by a program operation.

Operations for programming and erasing data in the nonvolatile memory cell may cause wear or damage to the nonvolatile memory cell. As the operations of programming and erasing data in the nonvolatile memory cell occur, wear-out of the nonvolatile memory cell might be accumulated, so that a lifespan expectancy of the memory device 150 which reliably may store and may output data stored in the nonvolatile memory cell is determined based on the number of operations for programming and erasing data (e.g., an E/W cycle). Typically, a memory block in the memory device 150 may reliably store and output data for thousands or tens of thousands of programs and erase operations.

With respect to wear degrees regarding the plurality of memory blocks in the memory device 150, the larger the deviation of wear degrees between the various memory blocks of a memory device is, the lower the performance of the memory system 110 also is. This is because when the deviation in the wear degrees between the plurality of memory blocks increases, the likelihood of failing to store or output the data reliably also increases, depending on a physical location, i.e., where the data is stored in the memory device 150. Accordingly, the controller 130 may control an internal operation of the memory system 110 to evenly perform an operation in which data is programmed or erased in each memory block, for reducing wear deviation between the plurality of memory blocks in the memory device 150. For example, when more programming and erasing operations are performed in a specific memory block than in other memory blocks, the controller 130 should reduce a frequency of programming or erasing data in the corresponding memory block.

For performing the above-described operation, a data attribute stored in the memory device 150 may be recognized. The data attribute may be classified into hot, cold, or warm. The hot data corresponds to a case where access to data occurs frequently. When reading, writing, or erasing frequently occurs on a specific piece of data, the nonvolatile memory cell storing the data may be frequently read or the stored data may be frequently reprogrammed at another location in the memory device 150. Such data may increase a wear rate of the nonvolatile memory cells in the memory device 150 relatively more than other data.

When an operation such as reading, writing, or erasing specific data is not frequently performed (cold data), it is not necessary to frequently read a nonvolatile memory cell that may store the data, and to frequently reprogram the data in another location. Such data may increase the wear rate of the nonvolatile memory cell in the memory device 150 relatively less than hot or warm data.

When the controller 130 uses a data attribute regarding data based on the relative frequency of the data, wear deviation between the plurality of memory blocks in the memory device 150 may be reduced. The data attribute may be variously established according to an embodiment. For example, according to an embodiment, the data attribute may be divided into two types, e.g., hot and cold, or three types, e.g., hot, warm, and cold. According to an embodiment, the controller 130 may control the plurality of memory blocks in the memory device 150 by dividing the data attribute into a larger number of types. The criteria for determining whether data is hot, cold, or warm may also vary.

The controller 130 may include a data input/output (I/O) control circuitry 198 which is configured to receive data from an external device (e.g., a host) or output data from the memory device 150 to the external device. When the data input/output control circuitry 198 receives a request for reading a specific piece of data from an external device, the data input/output control circuitry 198 may output the piece of data stored in a memory block 40_1 of the memory device 150.

As used in the disclosure, the term ‘circuitry’ refers to any and all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” also covers an implementation of merely a processor (or multiple processors) or portion of a processor and its (or their) accompanying software and/or firmware. The term “circuitry” also covers, for example and if applicable to a particular claim element, an integrated circuit for a storage device.

A command received from an external device for accessing data stored in the memory device 150 may be transmitted to the controller 130 along with a logical address used by the external device. The data input/output control circuitry 198 may translate the logical address into a physical address of the memory device 150 so that the memory device 150 may perform an operation corresponding to the received command from the external device (e.g., read, write, or erase operation).

When the data input/output control circuitry 198 accesses data, a data attribute determination circuitry 196 may increase an access count corresponding to a logical address processed by the data input/output control circuitry 198. The data attribute determination circuitry 196 may monitor the operations performed by the data input/output control circuitry 198 for each logical address, so that the data attribute determination circuitry 196 may know how many or how often operations such as read, write, and erase have been performed for each logical address. The data attribute determination circuitry 196 may determine a data attribute associated with the logical address based on an access frequency of each logical address. For example, the data attribute determination circuitry 196 may determine a data attribute associated with a logical address as hot or cold, or as hot, cold or warm, or as one of more groups depending on the access frequency of the logical address.

According to an embodiment, the data attribute determination circuitry 196 may determine the data attribute based on the logical address. The data attribute determination circuitry 196 may monitor and refer to not only data access in response to the command from the external device but also data access caused by an internal operation of the memory system 110. Herein, the internal operation may include operations such as garbage collection and wear leveling. Even when the data input/output control circuitry 198 may use a physical address in the memory device 150, the map data for associating the physical address with the logical address should be updated so that an external device can access corresponding data based on the logical address. When the data input/output control circuitry 198 monitors an operation for updating the map data, it is possible to check an access frequency of specific data handled by the internal operation. In addition, because a physical location for data is associated with a specific logical address when updating the map data, a result of the internal operation may be reflected in determining a data attribute based on the logical address.

According to an embodiment, the data attribute determination circuitry 196 may determine that the data attribute is hot, or cold, (or hot, cold, or warm), based on an access frequency regarding data for a predetermined period from a time when the data is stored in the memory device 150 to a time when a request for inquiring the data attribute is received from an external device. In another embodiment, the data attribute determination circuitry 196 may determine that the data attribute is hot, or cold, (or hot, cold, or warm), based on an access frequency regarding data during a predetermined period after an external command is received from the external device. The predetermined period may be variously selected. For example, the predetermined period may be an hour, a day, a week, or a month.

After the data attribute determination circuitry 196 determines a data attribute associated with each logical address, a data attribute transmission circuitry 194 may transmit the data attributes for the logical addresses to the external device. Because a data attribute may generally vary depending on the individual usage environment of the memory system 110, it might be known that a conventional memory system 110 does not have to output the data attribute to the external device even after the data attribute has been determined.

However, in an embodiment, the memory system 110 may determine the data attribute for each logical address and share the data attribute to an external device, or may receive the data attribute from the external device. When the memory system 110 receives a data attribute from the external device, the memory system 110 may refer to the data attribute for determining a physical address in the memory device 150 for newly programmed data, without monitoring data access pattern to determine the data attribute. Accordingly, the memory system 110 does not have to monitor a data access pattern for a certain period after storing data, thereby reducing resources (e.g., time and power) required to determine the data attribute.

The data attribute transmission circuitry 194 may output a data attribute which is determined in a unit of logical address in response to a command received from the external device inquiring about the data attribute. In an embodiment, when the controller 130 checks a preset time after data is newly stored in the memory system 110 to determine the data attribute, the data attribute transmission circuitry 194 may voluntarily output the data attribute to the external device even when there is no command from the external device. In this case, the external device does not transmit a specific command to the memory system 110, but may be in an operating state capable of receiving and recognize the data attribute from the memory system 110.

According to an embodiment, the memory system 110 may transmit a data attribute to the external device in response to a command received from the external device for erasing data corresponding to a specific logical address instead of a command for inquiring the data attribute. The memory system 110 may monitor an operation regarding specific data from a time when the specific data is newly programmed to a time when the specific data is erased (e.g., during a data lifetime). The memory system 110 may monitor an access pattern of the specific data during a lifetime of the specific data to determine a data attribute regarding the specific data, and then output the data attribute to the external device.

Hereinafter, various embodiments of the disclosure will be described in more detail with reference to FIGS. 2 to 9.

FIG. 2 illustrates a data processing system 100 in accordance with an embodiment of the disclosure is described. Referring to FIG. 2, the data processing system 100 may include a host 102 and a memory system 110.

The host 102 may include a portable electronic device such as a mobile phone, an MP3 player and a laptop computer or an electronic device such as a desktop computer, a game player, a television (TV), and a projector.

The host 102 also includes at least one operating system (OS), which may generally manage, and control, functions and operations performed in the host 102. The OS may provide interoperability between the host 102 engaged with the memory system 110 and the user using the memory system 110. The OS may support functions and operations corresponding to user's requests. By way of example but not limitation, the OS may be classified into a general operating system and a mobile operating system according to mobility of the host 102. The general operating system may be split into a personal operating system and an enterprise operating system according to system requirements or user's environment. The personal operating system, including Windows and Chrome, may be subject to support services for general purposes. But the enterprise operating systems can be specialized for securing and supporting high performance, including Windows servers, Linux, and Unix. Further, the mobile operating system may include an Android, an i0S, and a Windows mobile. The mobile operating system may be subject to support services or functions for mobility (e.g., a power saving function). The host 102 may include a plurality of operating systems. The host 102 may execute multiple operating systems interlocked with the memory system 110, corresponding to a user's request. The host 102 may transmits a plurality of commands corresponding to the user's requests into the memory system 110, thereby performing operations corresponding to commands within the memory system 110.

The memory system 110 may perform a specific operation in response to a request from the host 102 and, particularly, may store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, and a memory stick.

The storage devices for the memory system 110 may be implemented with a volatile memory device, for example, a dynamic random access memory (DRAM) and a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM) and a flash memory.

The memory system 110 may include a controller 130 and a memory device 150. The memory device 150 may store data to be accessed by the host 102. The controller 130 may control storage of data in the memory device 150. In the memory system 110, there are plural types of data. One is user data which includes information generated by the host 102 or inputted from a user through the host 102. Another is firmware for performing an operation of the memory system 110. Another is meta data including a piece of data that provides information about other data. For example, the meta data may support the operation performed within the memory system 110. The metadata is used for the management of the stored information or data in the NAND flash memory. The metadata generally includes, a logical-to-physical address mapping table of the stored information, information of attributes of the stored information, and any other data that can assist in the management of the stored information. According to an embodiment, the metadata can be stored as a block in a file system. Partial metadata may be updated after a read or write operation is performed.

The controller 130 and the memory device 150 may be integrated into a single semiconductor device, which may be included in the various types of memory systems as exemplified above.

By way of example but not limitation, the controller 130 and the memory device 150 may be integrated into a single semiconductor device. The controller 130 and memory device 150 configuring an SSD may be integrated into a single semiconductor device, for improving an operation speed. When the memory system 110 is used as an SSD, the operating speed of the host 102 connected to the memory system 110 can be improved more than that of the host 102 implemented with a hard disk. In addition, the controller 130 and the memory device 150 integrated into one semiconductor device may form a memory card. For example, a PC card (PCMCIA), a compact flash card (CF), a memory card such as a smart media card (e.g., SM, SMC), a memory sticks, a multimedia card (e.g., MMC, RS-MMC, MMCmicro), a secure digital (SD) card (e.g., SD, miniSD, microSD, SDHC), and a universal flash memory.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device and may retain data stored therein even while an electrical power is not supplied. The memory device 150 may store data provided from the host 102 through a write operation, while providing data stored therein to the host 102 through a read operation. The memory device 150 may include a plurality of memory blocks 152, 154, 156. Each of the memory blocks 152, 154, 156 may include a plurality of pages. Each of the plurality of pages may include a plurality of memory cells to which a plurality of word lines (WL) are electrically coupled. The memory device 150 also includes a plurality of memory dies each of which includes a plurality of planes, each of which includes a plurality of memory blocks 152, 154, 156. In addition, the memory device 150 may be a non-volatile memory device, for example a flash memory, wherein the flash memory may be a three-dimensional stack structure.

The controller 130 may control overall operations of the memory device 150, such as read, write, program, and erase operations. For example, the controller 130 may control the memory device 150 in response to a request from the host 102. The controller 130 may provide the data, read from the memory device 150, with the host 102. The controller 130 may store the data, provided by the host 102, into the memory device 150.

The controller 130 may include a host interface (I/F) 132, a processor 134, error correction code (ECC) circuitry 138, a power management unit (PMU) 140, a memory interface (I/F) 142 and a memory 144, all operatively coupled via an internal bus.

The host interface 132 may process commands and data provided from the host 102. The host interface 132 may communicate with the host 102 through at least one of various interface protocols such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (TATA), small computer system interface (SCSI), enhanced small disk interface (ESDI) and integrated drive electronics (IDE). In accordance with an embodiment, the host interface 132 is a component for exchanging data with the host 102, which may be implemented through a firmware called a host interface layer (HIL).

The ECC circuitry 138 may correct error bits of the data to be processed in (e.g., outputted from) the memory device 150, which may include an ECC encoder and an ECC decoder. Here, the ECC encoder may perform error correction encoding on data to be programmed in the memory device 150 to generate encoded data into which a parity bit is added and store the encoded data in memory device 150. The ECC decoder may detect and correct errors contained in data read from the memory device 150 when the controller 130 reads the data stored in the memory device 150. In other words, after performing error correction decoding on the data read from the memory device 150, the ECC circuit 138 may determine whether the error correction decoding has succeeded and output an instruction signal (e.g., a correction success signal or a correction fail signal). The ECC circuitry 138 may use the parity bit which is generated during the ECC encoding process, for correcting the error bit of the read data. When the number of the error bits is greater than or equal to a threshold number of correctable error bits, the ECC circuitry 138 may not correct error bits but may output an error correction fail signal indicating failure in correcting the error bits.

The ECC circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), and a Block coded modulation (BCM). The ECC circuitry 138 may include all or some of circuits, modules, systems or devices for performing the error correction operation based on at least one of the above described codes.

The PMU 140 may manage an electrical power provided in the controller 130.

The memory interface 142 may serve as an interface for handling commands and data transferred between the controller 130 and the memory device 150, to allow the controller 130 to control the memory device 150 in response to a request from the host 102. The memory interface 142 may generate a control signal for the memory device 150 and may process data entered into or outputted from the memory device 150 under the control of the processor 134 in a case when the memory device 150 is a flash memory and, in particular, when the memory device 150 is a NAND flash memory. The memory interface 142 may provide an interface for handling commands and data between the controller 130 and the memory device 150, for example, operations of NAND flash interface, in particular, operations between the controller 130 and the memory device 150. In accordance with an embodiment, the memory interface 142 may be implemented through a firmware called a flash interface layer (FIL) as a component for exchanging data with the memory device 150.

The memory 144 may support operations performed by the memory system 110 and the controller 130. The memory 144 may store temporary or transactional data for operations in the memory system 110 and the controller 130. The controller 130 may control the memory device 150 in response to a request from the host 102. The controller 130 may deliver data read from the memory device 150 to the host 102. The controller 130 may store data entered through the host 102 within the memory device 150. The memory 144 may be used to store data required for the controller 130 and the memory device 150 to perform operations such as read operations or program (or write) operations.

The memory 144 may be implemented with a volatile memory. The memory 144 may be implemented with a static random-access memory (SRAM), a dynamic random-access memory (DRAM) or both. Although FIG. 1 exemplifies the memory 144 disposed within the controller 130, the embodiment is not limited thereto. That is, the memory 144 may be located inside or outside the controller 130. For instance, the memory 144 may be embodied by an external volatile memory having a memory interface transferring data and/or signals transferred between the memory 144 and the controller 130.

The memory 144 may store data necessary for performing operations such as data writing and data reading requested by the host 102 and/or data transfer between the memory device 150 and the controller 130 for background operations such as garbage collection and wear levelling as described above. In accordance with an embodiment, for supporting operations in the memory system 110, the memory 144 may include a program memory, a data memory, a write buffer/cache, a read buffer/cache, a data buffer/cache, and a map buffer/cache.

The processor 134 may be implemented with a microprocessor or a central processing unit (CPU). The memory system 110 may include one or more processors 134. The processor 134 may control the overall operations of the memory system 110. By way of example but not limitation, the processor 134 may control a program operation or a read operation of the memory device 150, in response to a write request or a read request from the host 102. In accordance with an embodiment, the processor 134 may execute firmware to control the overall operations of the memory system 110. Herein, the firmware may be referred to as a flash translation layer (FTL). The FTL may perform an operation as an interface between the host 102 and the memory device 150. The host 102 may transmit requests for write and read operations to the memory device 150 through the FTL.

The FTL may manage operations of address mapping, garbage collection and wear-leveling. Particularly, the FTL may load, generate, update, or store map data. Therefore, the controller 130 may map a logical address, which is entered from the host 102, with a physical address of the memory device 150 through the map data. The memory device 150 may look like a general storage device to perform a read or write operation because of the address mapping operation. Through the address mapping operation based on the map data, when the controller 130 tries to update data stored in a particular page, the controller 130 may program the updated data on another empty page and may invalidate old data of the particular page (e.g., update a physical address, corresponding to a logical address of the updated data, from the previous particular page to the another newly programed page) due to a characteristic of a flash memory device. Further, the controller 130 may store map data of the new data into the FTL.

For example, the controller 130 uses the processor 134 for performing an operation requested from the host 102 in the memory device 150. The processor 134 may handle instructions or commands corresponding to a command from the host 102. The controller 130 may perform a foreground operation as a command operation, corresponding to a command from the host 102, such as a program operation corresponding to a write command, a read operation corresponding to a read command, an erase (or discard) operation corresponding to an erase (or discard) command and a parameter set operation corresponding to a set parameter command or a set feature command with a set command.

For another example, the controller 130 may perform a background operation on the memory device 150 through the processor 134. By way of example but not limitation, the background operation for the memory device 150 includes an operation (e.g., a garbage collection (GC) operation) for copying and storing data stored in an arbitrary memory block among the memory blocks 152, 154, 156 in the memory device 150 to another arbitrary memory block. The background operation may include an operation (e.g., a wear leveling (WL) operation) to move (or swap) between data stored in at least one of the memory blocks 152, 154, 156 in memory device 150 to at least another of the memory blocks 152, 154, 156. As the background operation, the controller 130 uses the processor 134 for storing the map data stored in the controller 130 to at least one of the memory blocks 152, 154, 156 in the memory device 150, e.g., a map flush operation. A bad block management operation for checking bad blocks in the plurality of memory blocks 152, 154, 156 in the memory device 150 is one of other background operation examples performed by the processor 134.

In accordance with an embodiment, the controller 130 and the memory 144 shown in FIG. 1 may be implemented through at least one processor 134 and at least one memory 144 in the controller 130 described in FIG. 2.

In the memory system 110, the controller 130 performs a plurality of command operations corresponding to a plurality of commands from the host 102. For example, when performing a plurality of program operations corresponding to a plurality of program commands, a plurality of read operations corresponding to a plurality of read commands and a plurality of erase operations corresponding to a plurality erase commands sequentially, randomly or alternatively, the controller 130 may determine which channel(s) or way(s) in a plurality of channels (or ways) for connecting the controller 130 to a plurality of memory dies in the memory 150 is/are proper or appropriate for performing each operation. The controller 130 may transmit data or instructions via determined channels or ways for performing each operation. The plurality of memory dies in the memory 150 may transmit an operation result via the same channels or ways, respectively, after each operation is complete. Then, the controller 130 may transmit a response or an acknowledge signal to the host 102. In an embodiment, the controller 130 may check a status of each channel or each way. In response to a command from the host 102, the controller 130 may select at least one channel or way based on the status of each channel or each way so that instructions and/or operation results with data may be delivered via selected channel(s) or way(s).

By way of example but not limitation, the controller 130 may recognize statuses regarding a plurality of channels (or ways) associated with a plurality of memory dies in the memory device 150. The controller 130 may determine each channel or each way as one of a busy state, a ready state, an active state, an idle state, a normal state and/or an abnormal state. The determination of which channel or way an instruction (and/or a data) is delivered through may be associated with a physical block address, e.g., which die(s) the instruction (and/or the data) is delivered to. The controller 130 may refer to descriptors delivered from the memory device 150. The descriptors may include a block or page of parameters that describe something about the memory device 150, which is data with a predetermined format or structure. For instance, the descriptors may include device descriptors, configuration descriptors, and unit descriptors. The controller 130 may refer to the descriptors to determine which channel(s) or way(s) an instruction or data is exchanged via.

A management unit (not shown) may be included in the processor 134. The management unit may perform bad block management for the memory device 150. The management unit may find bad memory blocks in the memory device 150, which are in unsatisfactory condition for further use. Further, the management unit may perform bad block management on the bad memory blocks. When the memory device 150 is a flash memory, for example, a NAND flash memory, a program failure may occur during the program operation, due to characteristics of a NAND logic function. During the bad block management, the data of the program-failed memory block or the bad memory block may be programmed into a new memory block. The bad blocks may seriously aggravate the utilization efficiency of the memory device 150 having a 3D stack structure and the reliability of the memory system 110. Thus, reliable bad block management may improve performance of the memory system 110.

FIG. 3 illustrates a controller in a memory system in accordance with an embodiment of the disclosure. The controller 130 cooperates with the host 102 and the memory device 150. The controller 130 may include a host interface (I/F) 132, a flash translation layer (FTL) 240, a memory interface (I/F) 142 and a memory 144.

Although not shown in FIG. 3, the ECC circuit 138 in FIG. 2 may be included in the flash translation layer 240. In another embodiment, the ECC circuit 138 may be implemented as a separate module, a circuit or firmware, which is included in, or associated with, the controller 130.

The host interface 132 may manage commands and data, which are received from the host 102. By way of example but not limitation, the host interface 132 may include a buffer manager 52, an event queue 54 and a command queue 56. The command queue 56 may sequentially store commands and data, which are received from the host 102, and output them to the buffer manager 52 in a stored order. The buffer manager 52 may classify, manage or adjust the commands and the data, which are delivered from the command queue 56. The event queue 54 may sequentially transmit events for processing the commands and the data, which are received from the buffer manager 52.

A plurality of commands or data with the same characteristic may be continuously transmitted from the host 102 to the memory system 110. Alternatively, commands and data with different characteristics may be transmitted to the memory system 110 after being mixed or jumbled. For example, a plurality of commands for reading data (i.e., read commands) may be delivered, or commands for reading data (i.e., read command) and commands for programming data (i.e., program or write command) may be alternately transmitted to the memory system 110. The host interface 132 may store commands and data, which are received from the host 102, to the command queue 56 sequentially, i.e., in the order received. Thereafter, the host interface 132 may determine what type of operation the controller 130 may perform according to the characteristics of the command and data in the command queue 56. The host interface 132 may determine a processing order and a priority of commands and data, based on their characteristics. According to the characteristics of the commands and data, the buffer manager 52 is configured to determine whether commands and data, are stored in the memory 144, or whether the commands and the data are delivered into the flash translation layer 240. The event queue 54 receives events, entered from the buffer manager 52, which are to be internally executed and processed by the memory system 110 or the controller 130 in response to the commands and the data from the host 102, so as to deliver the events into the flash translation layer 240 in the order received.

In accordance with an embodiment, the flash translation layer 240 may include a state manager (GC/WL) 42, a map manager (MM) 44, a host request manager (HRM) 46, and a block manager (BM/BBM) 48. The host request manager 46 may manage the events from the event queue 54. The map manager 44 may manage map data. The state manager 42 may perform garbage collection or wear leveling. By way of example but not limitation, the state manager 42 may include the wear levelling circuitry 198 of FIG. 1. The block manager 48 may execute commands or instructions onto a block in the memory device 150.

By way of example but not limitation, the host request manager 46 may use the map manager 44 and the block manager 48 to process requests according to the read and program commands and events which are delivered from the host interface 132. The host request manager 46 may send an inquiry request to the map data manager 44, for finding out the physical address corresponding to the logical address received with an event. The host request manager 46 may send a read request with the physical address to the memory interface 142, to process the read request (i.e., to process the received event). The host request manager 46 may send a program request (i.e., write request) to the block manager 48, to program data to a specific page (e.g., a page without data) in the memory device 150. Then, the host request manager 46 may transmit a map update request corresponding to the program request to the map manager 44, to update an item relevant to the programmed data in information of mapping between logical addresses and physical addresses.

The block manager 48 may convert a program request delivered from the host request manager 46, the map manager 44, and/or the state manager 42 into a flash program request used for the memory device 150, to manage flash blocks in the memory device 150. In order to enhance program performance of the memory system 110 (see FIG. 2), the block manager 48 may collect program requests and send flash program requests for multiple-plane and one-shot program operations to the memory interface 142. The block manager 48 may send several flash program requests to the memory interface 142 to enhance or maximize parallel processing of the multi-channel and multi-directional flash controller.

The block manager 48 may be configured to manage the blocks in the memory device 150 according to the number of valid pages in each block. For example, the block manager 48 may select and erase a block having no valid pages when a free block is needed. Or, also, as an example, the block manager 48 may select a block including the least number of valid pages when it is determined that garbage collection is necessary (e.g., the number of free memory block is less than a threshold). The state manager 42 may perform garbage collection to move the valid data of the selected block to an empty block (i.e., a free memory block) or an open block and erase the selected block to make it a free block (i.e., an empty block with no data). The state manager may procure enough free blocks for a next program operation. If the block manager 48 provides information regarding a block to be erased to the state manager 42, the state manager 42 may check all flash pages of the block to be erased to determine whether each page is valid. For example, to determine the validity of each page, the state manager 42 may identify a logical address stored in an out-of-band (OOB) area of each page. To determine whether each page is valid, the state manager 42 may compare the physical address of the page with the physical address mapped to the logical address obtained from the inquiry request. The state manager 42 sends a program request to the block manager 48 for each valid page. A mapping table may be updated through the update of the map manager 44 when the program operation is completed.

The map manager 44 may manage a logical-to-physical mapping table. The map manager 44 may process requests such as queries and updates, which are generated by the host request manager 46 or the state manager 42. The map manager 44 may store the entire mapping table in the memory device 150 (e.g., a flash/non-volatile memory) and cache mapping entries according to the storage capacity of the memory 144. When a map cache miss occurs while processing inquiry or update requests, the map manager 44 may send a read request to the memory interface 142 to load a relevant mapping table stored in the memory device 150. When the number of dirty cache blocks (e.g., dirty cache regions including dirty map data, dirty map table) in the map manager 44 exceeds a certain threshold, a program request may be sent to the block manager 48 so that a clean cache block is made after the dirty map table may be stored in the memory device 150.

When garbage collection is performed, the state manager 42 copies valid page(s) into a free block, and the host request manager 46 may program the latest version of the data for the same logical address of the page and currently issue an update request. When the status manager 42 requests the map update in a state in which copying of valid page(s) is not completed normally, the map manager 44 may not update the mapping table. It is because the map request is issued with old physical information if the status manger 42 requests a map update, then a valid page copy is completed later. The map manager 44 may perform a map update operation to ensure accuracy only if the latest map table still points to the old physical address.

The memory device 150 may include a plurality of memory blocks. The plurality of memory blocks may be classified into different types of memory blocks such as a single level cell (SLC) memory block or a multi-level cell (MLC) Cell) memory block, according to the number of bits that can be stored or represented in one memory cell. Here, the SLC memory block includes a plurality of pages implemented by memory cells, each storing one bit of data. The SLC memory block may have high data input/output (I/O) operation performance and high durability. The MLC memory block includes a plurality of pages implemented by memory cells, each storing multi-bit data (e.g, two bits or more). The MLC memory block may have larger storage capacity in the same space than the SLC memory block. The MLC memory block may be highly integrated in terms of storage capacity. In an embodiment, the memory device 150 may be implemented with MLC memory blocks such as an MLC memory block, a triple level cell (TLC) memory block, a quadruple level cell (QLC) memory block and a combination thereof. The MLC memory block may include a plurality of pages implemented by memory cells, each capable of storing 2-bit data. The triple level cell (TLC) memory block may include a plurality of pages implemented by memory cells, each capable of storing 3-bit data. The quadruple level cell (QLC) memory block may include a plurality of pages implemented by memory cells, each capable of storing 4-bit data. In another embodiment, the memory device 150 may be implemented with a block including a plurality of pages implemented by memory cells, each capable of storing 5-bit or more bit data.

In an embodiment of the disclosure, the memory device 150 is embodied as a nonvolatile memory such as a flash memory. The flash memory may be a NAND flash memory or a NOR flash memory. However, the memory device 150 may also be implemented by at least one of a phase change random access memory (PCRAM), a ferroelectrics random access memory (FRAM), a spin injection magnetic memory (STT-RAM), and a spin transfer torque magnetic random access memory (STT-MRAM).

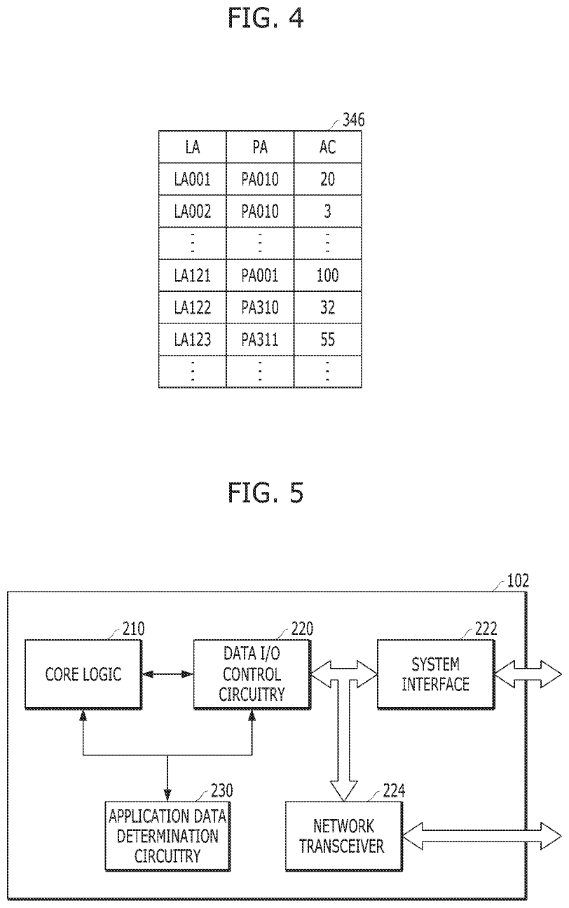

FIG. 4 illustrates an example of a data structure which is used for determining a data attribute in a memory system according to an embodiment of the disclosure.

Referring to FIG. 4, a map table 346 may be used as an example of a data structure used for determining a data attribute. Components in the memory system 110, such as the data input/output control circuitry 198 of FIG. 1 or the map manager 44 in FIG. 3, may generate and control the map table 346 for associating a logical address LA used by an external device or a host 102 (see FIGS. 2 to 3) with a physical address PA indicating a physical location of data in the memory device 150. The map table 346 may be used for determining the data attribute and may include an access count AC as well as the logical address LA and the physical address PA.

The access count AC corresponding to a specific logical address (e.g., LA121) may be increased when an operation corresponding to a command such as read, write, or erase associated with the corresponding logical address (e.g., LA121) is performed. According to an embodiment, the access count AC may be increased when data is accessed by an internal operation of the memory system 110 as well as an operation in response to a command from the host 102.

According to an embodiment, the access count AC may be reset after the data attribute determination circuitry 196 determines the data attribute corresponding to the logical address LA. The access count AC corresponding to a specific logical address may be increased for a predetermined time (or a reference time). The change of the access count AC may indicate a frequency of accessing data corresponding to the corresponding logical address. For example, the data attribute determination circuitry 196 in FIG. 1 determines a data attribute for a specific logical address, and the data attribute transmission circuitry 194 transfers the determined data attribute to the host 102. When the data attribute is received, the access count AC corresponding to the corresponding logical address may be initialized.

An access count AC corresponding to a specific logical address may be increased after a physical address is associated with the logical address. If there is no physical address associated with the corresponding logical address, the access count AC of the corresponding logical address may maintain an initialized state.

According to an embodiment, an access count AC corresponding to a specific logical address may not be increased when there is no command for requesting a data attribute from the host 102 even if the physical address is associated with the corresponding logical address. For example, the controller 130 may start to increase the access count AC in response to a command for requesting the data attribute from the host 102.

According to an embodiment, the access count AC may be generated individually corresponding to each of all logical addresses, or correspond to each of some logical addresses in response to a command for requesting a data attribute, which is received from the host 102.

The access count AC may be independently controlled for each logical address. For example, it is assumed that the access count AC of the logical address LA001 may be 20 and the access count AC of the logical address LA121 may be 100. If the access count AC is greater than or equal to a reference value (e.g., 50), a data attribute may be determined as hot. If the access count AC is less than the reference value, the data attribute may be determined as cold. Herein, a data attribute corresponding to the logical addresses ‘LA121,’ ‘LA123’ may be determined as hot, but the data attribute corresponding to the logical addresses ‘LA001,’‘LA002,’‘LA122’ may be determined as cold.

The reference value for determining the data attribute may be dynamically changed. The reference value for determining the data attribute may be fixed. When the reference value may be changed, the reference value may vary depending on the period when the access count (AC) is increased. For example, the reference value may be greater when access counts corresponding to logical addresses have been increased for one week than when the access counts corresponding to the logical addresses have been increased for one day.

The memory system 110 as shown in FIGS. 1 to 3 may refer to an access count AC corresponding to a logical address LA, and may determine a data attribute corresponding to the logical address LA. The memory system 110 may determine the data attribute for the logical address LA, and then transfer the data attribute corresponding to the logical address LA to the host 102.

FIG. 5 illustrates a host 102 according to an embodiment of the disclosure.

Referring to FIG. 5, the host 102 may include a core logic 210, data input/output (I/O) control circuitry 220, application data determination circuitry 230, a network transceiver 224 and a system interface.

The data input/output control circuitry 220 may be configured to control data inputted to, or outputted from, the host 102. The data input/output control circuitry 220 may be engaged with the system interface 222 and the network transceiver 224. The system interface 222 receives data from another device which is coupled with the host 102 (e.g., the memory system 110), or transmits data to another device. For example, the system interface 222 may control transmission and reception regarding data and/or commands in a data processing system including the host 102 and at least one memory system 110. According to an embodiment, the system interface 222 may support a protocol for serial data communication and/or parallel data communication.

The system interface 222 may support a synchronous serial communication scheme. The system interface 222 may support an asynchronous serial communication scheme. By way of example but not limitation, in a synchronous serial communication scheme, the system interface 222 may synchronize an operation of a data line with an operation of a clock signal line, and devices connected through a serial bus may share a common clock signal. This scheme may be intuitive and can often work more quickly than another scheme. However, this scheme requires one additional line. Representative examples of synchronous serial communication may include a serial peripheral interface (SPI) protocol and a serial communication protocol such as an inter-integrated circuit (I2C) protocol. In an asynchronous serial communication scheme that can be supported by the system interface 222, data may be transmitted without an external clock signal, and the system interface 22 may stably transmit or receive the data to or from another device. A representative example of an asynchronous serial communication method is a universal asynchronous receiver and transmitter (UART) protocol.

A network transceiver 224 operatively engaged with the data input/output controller 220 may perform a function of connecting the host 102 to a communication network or a telecommunications network. The host 102 may exchange data with another host or a network server through the network transceiver 224. By way of example but not limitation, the network transceiver 224 may support transmission control protocol/internet protocol (TCP/IP), which is a protocol for enabling data communication in a local area network (LAN) or a wide area network (WAN) between a computing device or a host and another computing device or another host.

The data input/output control circuitry 220 may receive a data attribute from the memory system 110 through the system interface 222. Because the data attribute from the memory system 110 corresponds to the logical address LA, the core logic 210 may determine which application or program generates or involves data associated with the logical address LA.

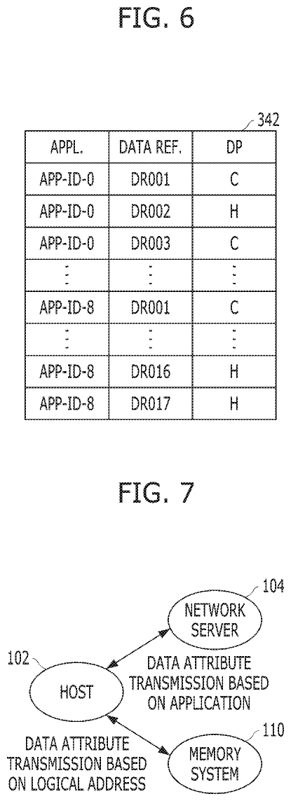

If it is determined that the data attribute through the data input/output control circuitry 220 is linked to data constituting a specific application or program, the application data determination circuitry 230 may match the data attribute to a data structure used for managing application data, which is described in FIG. 6.

The host 102 may install, use, execute or manage a plurality of applications including an operating system. The memory system 110 just may store data which the host 102 instructs to or requests to store. However, the memory system 110 may not recognize which application involves data that the host 102 instructed to store. Accordingly, when the memory system 110 may transmit a data attribute corresponding to the logical address LA to the host 102, the host 102 may determine which application or operating system involves data corresponding to the logical address LA associated with the data attribute from the memory system 110.

The application used by the host 102 may include at least one file or a plurality of data structures. For example, the host 102 may request an available space in the memory system 110 for a specific application, and the host 102 can instruct the memory system 110 to store data generated by the application therein. The host 102 may assign at least one logical address LA to the specific application, for example, a size of the space allocated for the specific application. The host 102 may receive the data attribute corresponding to the logical address LA, which is received from the memory system 110. The host 102 may determine which application involves data corresponding to the logical address LA which is associated with the data attribute received from the memory system 110.

FIG. 6 illustrates an example of a data structure which is used for classifying a data attribute in a host according to an embodiment of the disclosure.

Referring to FIG. 6, the host 102 of FIG. 5 generates a data table 342 used for associating a data property DP corresponding to a data reference number (DATA REF.) with an application APPL. Herein, the data property DP may be matched with the data attribute described in FIGS. 1 to 5 and may include hot (H) or cold (C). A plurality of applications used by the host 102 may be classified or distinguishable from each other, based on a name of the application. In FIG. 6, the plurality of applications may be distinguishable from each other based on the application ID numbers APP-ID-0 to APP-ID-8. How the host 102 distinguishes each application from each other may be different according to an embodiment.

In an embodiment, each application may have at least one data reference number (DATA REF.). For example, the first application APP-ID-0 may include a plurality of data reference numbers DR001, DR002, DR003. For example, the data reference number may correspond to a storage space requested by the first application APP-ID-0 from the host 102. It may be assumed that the first application APP-ID-0 requires 10 MB of storage space from the host 102, and a size allocated to one logical address used by the host 102 is 500 KB. In this case, the host 102 may assign 20 logical addresses to the first application APP-ID-0. The 20 logical addresses may correspond to 20 data reference numbers (DATA REF.) assigned to the first application APP-ID-0.

According to an embodiment, a method of determining a data reference number assigned to an application used by the host 102 may vary. The application may request a data reference number (DATA REF.) corresponding to a file system used by the host 102. The file system may control how data is stored and retrieved. Structure and logic rules used to manage groups of information and their names may be considered a “file system.” In addition, according to an embodiment, the application may generate a plurality of files and a plurality of data structures. The host 102 may assign at least one data reference number (DATA REF.) which corresponds to a file and a data structure included in the application.

The data reference number (DATA REF.) may be determined in various ways corresponding to a file system used by the host 102. In an embodiment, the data reference number (DATA REF.) which is requested by the application or given by the host 102 may correspond to a logical address shared between the host 102 and the memory system 110.

The host 102 may receive a data attribute (e.g., Hot, Cold) corresponding to a logical address from the memory system 110. The host 102 may determine which application involves data corresponding to the logical address, and which data reference number in the application is matched with the logical address. Thereafter, the application data determination unit circuitry (refer to FIG. 5) in the host 102 may associate the data attribute with the data reference number, in order to generate the data table 342.

FIG. 7 illustrates how to transmit and receive a data attribute between a network server 104, a host 102, and a memory system 110 according to an embodiment of the disclosure.

Referring to FIG. 7, a data attribute may be transmitted and received between the network server 104, the host 102, and the memory system 110. The memory system 110 may be implemented as shown in FIGS. 1 through 3. The host 102 may be implemented as shown in FIGS. 2 through 3 and 5.

The memory system 110 may transmit and receive a data attribute based on a logical address used between the host 102 and the memory system 110. For example, the memory system 110 may transfer the data attribute corresponding to a logical address to the host 102. When the host 102 transmits a command including data, the logical address, and the data attribute to the memory system 110, the memory system 110 may recognize the data attribute corresponding to the logical address. The memory system 110 may determine the physical location (i.e., a physical address) of the memory device 150 in which the data is programmed.

A data attribute may be transmitted and received between the host 102 and the network server 104 on an application basis. As shown in FIG. 5, the host 102 may associate the data attribute corresponding to a logical address, which is received from the memory system 110, with an application. For example, when the host 102 downloads a specific application from the network server 104, the host 102 may receive data attributes associated with data in the application. The host 102 may check the data attributes regarding a plurality of files and a plurality of data structures in the application, and then transfer the data attributes and the data together with a write command to the memory system 110. In this case, the host 102 may transfer the data attribute corresponding to the logical address assigned for the application to the memory system 110.

In an embodiment, the host 102 may transmit the data attributes, which are received from the memory system 110, to the network server 104. The host 102 may reorganize (or reconfigure) the data attributes corresponding to the logical addresses based on an application, and transfer the data attributes to the network server 104 based on the application.

Both determining a data attribute regarding data programmed in the memory system 110 internally and determining a location where the data is stored in response to the data attribute may improve operational performance (e.g., a lifespan and a reliability) of the memory system 110. In an embodiment, the data attribute determined by the memory system 110 may be transmitted to the network server 104 through the host 102. The network server 104 may transmit the data along with the data attributes into a plurality of hosts or a plurality of devices. For example, the data attribute may be included in an application which could be distributed via a network from the network server 104, and the application including data and data attribute may be delivered into a plurality of hosts 102. Because the data attribute may be shared when the host 102 downloads the application and may store the application in the memory system 110, the memory system 110 may recognize and use the data attribute when corresponding data is programmed therein. Unlike a case when an attribute of programmed data is not recognized, the embodiment may provide the memory system 110 which is capable of storing data based on the attribute and reducing resources required to determine the attribute of data for a certain time. Also, rather than predicting data attributes when an application is designed, the data attributes may be determined based on an access frequency in the memory system 110 including a nonvolatile memory device during a predetermined time. The data attributes may be collected from plural devices such as the host 102 using or employing the same application, and the collected data attributed may be averaged in order to generalize the data attribute regarding the application.

In an embodiment, a plurality of hosts 102 may be utilized to determine a data attribute corresponding to a piece of data involved in an application or a computer program. Cloud computing may be used to determine the data attribute, so that each memory system may reduce resources required for monitoring a data access pattern and determining the data attribute based on the data access pattern. Since waste of resources may be avoided, more efficient operation may be performed in the memory system 110 to improve performance of the memory system 110.

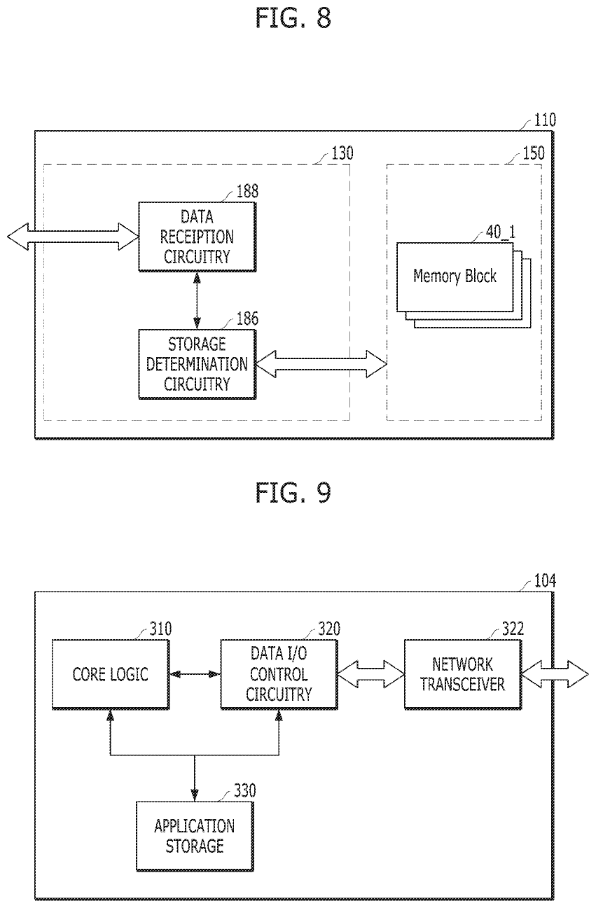

FIG. 8 illustrates a memory system 110 according to an embodiment of the disclosure.

Referring to FIG. 8, the memory system 110 may include a controller 130 and a memory device 150. The memory system 110 may receive a data attribute from an external device (e.g., the host 102 of FIGS. 1 to 3, 5, and 7). The data attribute is transferred in correspondence with the logical address, and the memory system 110 may determine a physical location for the data corresponding to the logical address in the memory device 150 based on the data attribute. For example, the memory device 150 may include a plurality of memory blocks 40_1. When a memory block among the plurality of memory blocks 40_1 may store data having the same attribute and data having different attributes are stored in different memory blocks, a lifespan of the memory device 150 may be extended and operational stability may be improved. When the controller 130 receives the data attribute, the controller 130 does not need to discover the data attribute stored in the memory device 150. That is, in response to a program command and the data attribute from the external device, the controller 130 may select a memory block in the memory device 150, which is allocated for storing data having a specific data attribute.

The memory system 110 in FIG. 1 may determine a data attribute regarding data from an external device (e.g., the host 102), and transfer the data attribute to the host 102. Unlike the memory system 110 in FIG. 1, the memory system 110 in FIG. 8 may determine a physical location to store data based on the data attribute from the host 102.

In an embodiment, the memory system 110 in FIGS. 1 and 8 may be implemented with a single device. For example, the memory system 110 may determine a data attribute and output the data attribute to an external device, or may store inputted data based on an inputted data attribute in response to a command from the host 102.

According to an embodiment, in response to a request of an application downloaded by the host 102, the memory system 110 may determine a data attribute regarding data involved in the application, and transmit the data attribute to the network server 104 (see FIG. 7) which distributes the application via a network. For example, the application may include a program code used for collecting a data attribute regarding data involved therein. After the application inputted through the host 102 is stored in the memory system 110, the program code may execute to make the memory system 110 monitor a data access pattern regarding data involved in the application. A data attribute may be determined based on the data access pattern. The memory system 110 may transfer the data attribute to the host 102, and the host 102 may transfer the data attribute to the network server 104. A process of transferring data attributes between the memory system 110 and the network server 104 may be performed as in the method described in FIG. 7.

FIG. 9 illustrates a network server 104 according to an embodiment of the disclosure.

Referring to FIG. 9, the network server 104 may include a core logic 310, data input/output (I/O) control circuitry 320, a network transceiver 322 and an application storage 330.

The data input/output control circuitry 320 may control data, which is inputted to the network server 104 or outputted from the network server 104. Further, the data input/output control circuitry 320 may be operatively coupled and engaged with the network transceiver 322. The network transceiver 322 may perform a function of connecting the network server 104 to a communication network and a telecommunications network. The network server 104 may exchange data with a host or another network server through the network transceiver 322. For example, the network transceiver 322 may support a protocol such as TCP/IP for enabling data communication between the network server 104 and a computing device or the host 102 in a local area network (LAN) or a wide area network (WAN). In detail, the network transceiver 322 may be connected to the network transceiver 224 of the host 102 in FIG. 5 via a local area network (LAN) or a wide area network (WAN) to transmit and receive data or application to or from the host 102.

When the host 102, shown in FIGS. 1 to 3, 5, and 7, requests an application from the network server 104, the data input/output control circuitry 320 may deliver the application to the host 102. The application may include at least one file or data structure which is a format to facilitate delivery over a local area network (LAN) or wide area network (WAN).

The application may include data attributes of data involved in, generated by, or included in the application. Further, the data attributes in the application may be updated periodically or according to an event.

For example, the application may include a program file and data files. In addition, the application may include information for setting resources required for the execution of the application. The resource may include a storage space, a file system, or a processor performance.

When an application is initially published and distributed, there may be no data attribute in the application. Information used for determining data attributes involved in the application might be not enough. However, after the application is distributed to multiple users, that is, a plurality of computing devices or a plurality of hosts 102 used by multiple users, the network server 104 distributing the application may collect data attributes from the plurality of hosts 102. When the data input/output control circuitry 320 in the network server 104 may collect data attributes from the plurality of hosts 102, the core logic 310 may determine a data attribute for data involved in or generated by the application.

When determining a data attribute in a computing device used by a user or the memory system 110, the data attribute may vary depending on an operational environment or a data access pattern or a data usage pattern of the user who uses the memory system 110 and the host 102. Accordingly, the network server 104 may more accurately determine the data attribute, as more data attributes are collected from a greater number of hosts 102.

In an embodiment, the network server 104 may determine a data attribute as a numerical value. For example, a data attribute regarding first data may be determined as a reference (e.g., 0), a data attribute regarding second data may be determined as +3, a data attribute regarding third data is +5, and a data attribute regarding fourth data is −2. Because each computing device or each host 102 operates in different operational environments or conditions, the network server 104 may provide the host 102 with data attributes including numerical values, and the host 102 may interpret the data attributes of numerical values, corresponding to its operational environment. The host 102 may determine a data attribute of classified value such as hot or cold based on the data attributes of numerical values from the network server 104.

The application storage 330 may store not only files and data structures involved in the application, but also data attributes of data constituting the application. In addition, a data attribute may be stored based on a version of the application, because the data attribute may be different according to the version of the application. The network server 104 may transmit the data attribute regarding the application corresponding to version information requested from the host 102.

According to an embodiment, the application storage 330 may store data attributes involved in a plurality of applications. The core logic 310 and the data input/output control circuitry 320 may provide the plurality of applications to a plurality of computing devices or hosts 102 and determine versions of the applications to be provided to the plurality of hosts 102. The data attributes may be provided to each host 192 and may be distinguished based on an application and its version distributed to the host 102.

The core logic 310 and the data input/output control circuitry 320 may notify a new version of application to the plurality of hosts 102. The new version of application may include data attributes.

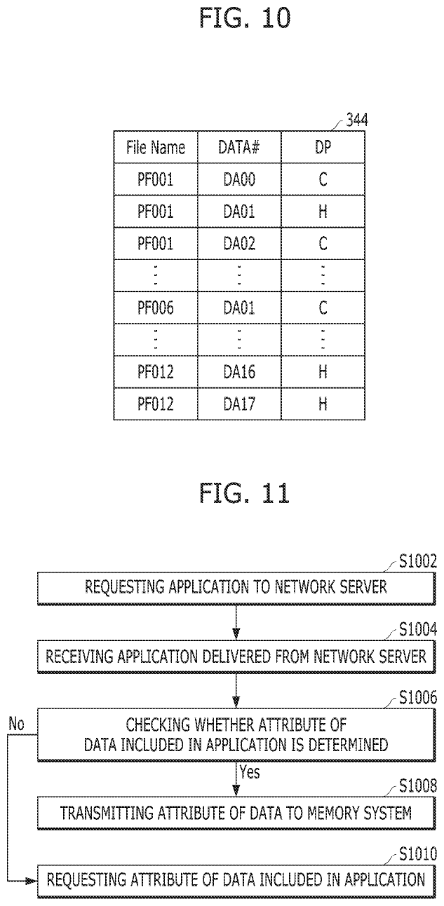

FIG. 10 illustrates an example of a data structure which is used for classifying a data attribute in a network server 104 according to an embodiment of the disclosure.

Referring to FIG. 10, the network server 104 may store a plurality of files PF001, . . . , PF0006, . . . , PF012 in an application attribute table 344. Each file may include at least one data number DATA#. In an embodiment, the data number DATA# may correspond to a logical address LA used between the memory system 110 and the host 102. The network server 104 may divide a storage space required for an application into a plurality of parts, each corresponding to a minimum unit set in a file system, to generate and assign the data number DATA# to each of the plurality of parts. A storage space required for each application may be different.

Even in the same application, there may be a difference in various methods for specifying data according to an operating system or a file system used in the host 102 or the computing device. Each application may include different versions, each corresponding to a different operating system used by the host 102 or the computing device. Further, data numbers DATA#, which are associated with data attributes, may be differently assigned to each version of application.

For example, a plurality of hosts 102 may individually transmit data attributes regarding a particular version of an application to the network server 104. The network server 104 may collect the data attributes from the plurality of hosts 102 by classifying the data attributes according to a version of the application such as a window version or a mobile version, which may describe an operational environment of each host 102.

In FIG. 10, a file may have different characteristics (e.g., names or sizes) for each version of an application, and the network server 104 may associate data attributes DP with a file, based on a plurality of data numbers DATA# assigned to the file, to generate the application attribute table 344. In the application attribute table 344, it is assumed that data involved in an application may be set as in a substantially same format or data structure and stored in the memory system when a version of the application are the same.

For example, a specific application stored in the network server 104 may be a single compressed or compiled file. When the specific application may be delivered to a specific host 102 and stored in the memory system 110 engaged with the specific host 102, it is assumed that the specific application requires a 1 MB storage space and 10 logical addresses may be assigned. When the corresponding application is stored in the memory system 110 after being delivered to another host and another memory system, the same storage space may be required, and the same number of logical addresses may be assigned. However, physical locations where data corresponding to ten logical addresses for the specific application may be different in each memory system 110. In addition, although the same number of logical addresses (e.g., 10) may be assigned by each host, the range of assigned logical addresses (e.g., 1˜10, 31˜40, or 201˜210) may be different. Therefore, the network server 104 may not store a data attribute DP corresponding to a specific logical address. Instead, the network server 104 may use the data number DATA# to store the data attribute DP. The host 102 may translate the data number DATA# into the logical address so that the data attribute DP inputted corresponding to the data number DATA# may be associated with the logical address.

The application attribute table 344 may store classified values such as hot (H) or cold (C) regarding the data attribute DP. However, according to an embodiment, as described above with reference to FIG. 9, the data attribute DP may be stored as a numerical value showing a relative difference. When the data attribute DP is stored as the numerical value, the host 102 may translate the numerical value to the classified value based on an operational environment.

According to an embodiment, the memory system 110 may perform an operation of changing the data attribute DP stored as a numerical value (0, 1, or 2) to the classified value such as hot (H) and cold (C). Because it is presumed that an operational environment inside the memory system 110 may be more accurately recognized by the controller 130, the memory system 110 may translate the numerical value of the data attribute DP into the classified value, thereby improving performance.

FIG. 11 is a flowchart illustrating a method of operating a host in a data processing system in accordance with an embodiment of the disclosure.

Referring to FIG. 11, the method of operating a host may include requesting an application to a network server (S1002), receiving an application delivered from the network server (S1004), and checking whether a data attribute regarding data involved in the application has been determined (S1006). The host may receive the application from the network server and store the application in a memory system operatively engaged with the host. In the process of storing the application in the memory system, the host or the memory system may check whether the application received from the network server includes information regarding the data attribute of data involved in the application.

When it is checked that the application from the network server includes the information regarding the data attribute (S1006, Yes), the host may transmit the data attribute to the memory system (S1008). When the data attributes are transmitted to the memory system by the host, the memory system may use the data attributes to determine where the data involved in the application is stored in the memory system. It might provide better performance in a case when data is stored in the memory system based on the data attributes rather than in another case when the data is simply stored regardless of the data attributes in the memory system.

When it is checked that the application from the network server does not include the data attribute (S1006, No), the host may request a version of the application, which includes the data attribute, to the network server (S1010). The network server may transmit to the host the version of the application including the data attribute of data, in response to the request of the host. However, according to an embodiment, when the network server does not have the version of the application including the data attribute, the network server may request the data attribute from the host or inquire of the host about the data attribute of data involved in the application.

When the application received from the network server does not include the data attribute (S1006, No), the host may inquire of the network server about whether the network server requires the data attribute. In response to a response of the network server, the host may check the data attribute and determine whether to transmit the data attribute to the network server.

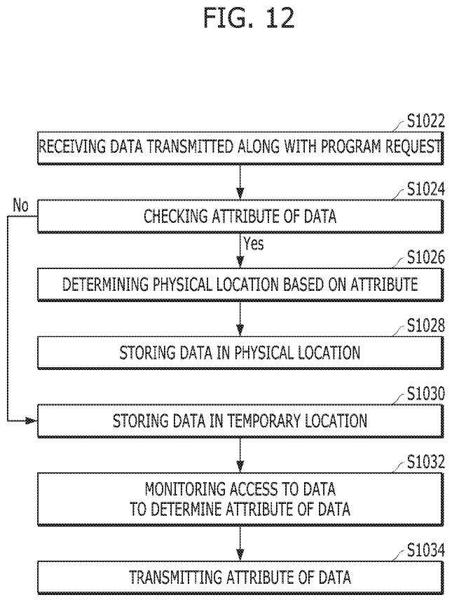

FIG. 12 is a flowchart illustrating a method of operating a memory system in a data processing system according to an embodiment of the disclosure.

Referring to FIG. 12, the method of operating a memory system may include receiving data transmitted along with a program request (S1022), checking a data attribute regarding the data received along with the program request (S1024), determining a physical location in a nonvolatile memory device based on the data attribute (S1026), and storing the data in the physical location (S1028). The nonvolatile memory device in which the application is stored may include a plurality of memory blocks shown in FIGS. 1 to 3. The plurality of memory blocks may include a memory block allocated for storing hot data, and another memory block allocated for storing cold data. For example, when the host transmits a write request (or a program request), a piece of data, and a data attribute of the piece of data together, the memory system may determine a memory block storing the piece of data based on the data attribute.

When the data attribute is not inputted along with the data from the host (‘No’ in step S1024), the memory system may store the data in a temporary (or arbitrary) location in the nonvolatile memory device (S1030). In a program operation, the memory system does not recognize the data attribute regarding the data. The memory system may monitor the access to the data (or check a data access pattern) to determine the data attribute (S1032). For example, the memory system may perform the operations described in FIG. 1 to monitor and determine the data attribute regarding the data.

According to an embodiment, in response to a request or a command inputted from a host or a computing device, the memory system may monitor access to stored data to determine the data attribute.

After determining the data attribute, the memory system may transmit the data attribute to the host or the computing device (S1034). Alternatively, the memory system may transmit the data attribute data to the host or the computing device in response to an instruction received from the host or the computing device.

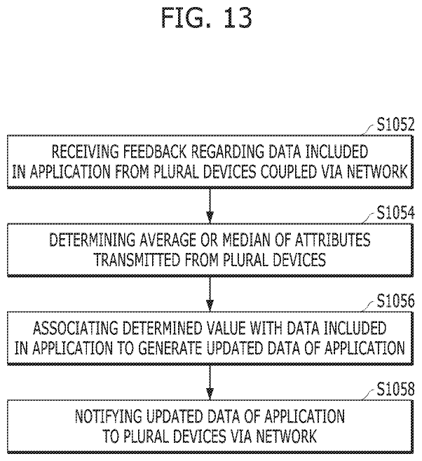

FIG. 13 is a flowchart illustrating a method for operating a network server according to an embodiment of the disclosure.

Referring to FIG. 13, the method of operating the network server may include receiving a feedback regarding data included in an application a plurality of applications coupled via a network (S1052), determining an average or a median of data attributes received from the plurality of devices (S1054), associating a determined value with the data included in the application to generate updated data for the application (S1056), and notifying the update data for the application to the plurality devices through the network (S1058).

The network server may be operatively coupled with a plurality of computing devices (or a plurality of hosts) through a network such as a local area network (LAN) or a wide area network (WAN). The network server may transmit an application in response to a request from the plurality of computing devices. After receiving the application, the plurality of computing devices may provide the data attribute regarding data involved in the application back to the network server. The network server may receive the data attributes from the plurality of computing devices (S1052).

The data attributes from a plurality of computing devices may be different from each other because the plurality of computing devices may be under different operational environments. After receiving the data attributes from the plurality of computing devices, the network server may determine the data attributes through a predetermined algorithm (S1054). For, example, the predetermined algorithm may be an average-finding or a median-finding algorithm. According to an embodiment, a data attribute which is closer to a general operational environment may be determined by an algorithm capable of calculating statistical meaning of a plurality of data. For example, the statistical meaning may include an average (in a case of numerical value) or a typical value (in a case of hot, warm or cold attribute).

Deviation of the data attributes may be varied depending on operational environments of the plurality of hosts, computing devices or memory systems. However, the number of times to determine the data attributes increases, as a time passes. Then, the deviation may be gradually decreased, because it is likely that the plurality of hosts, computing devices or memory systems may determine the data attribute under a general operational environment rather than a special operational environment.

The network server may collect information about data attributes and data on a periodic or event basis, determine data attributes of data involved in an application, and generate a data structure such as a table including the data attributes. Thereafter, the network server may generate update data of the application (i.e., a new version of the application) by include the data structure regarding the data attribute in an update version of the application (S1056).

The network server may notify whether to generate application update data (i.e., the new version of the application) to the plurality of computing devices (S1058). When the plurality of computing devices request a new version of the application, the network server may transmit the update version of the application including the data attribute.

After receiving data required for updating an application from the network server, a plurality of computing devices may update the application stored in the memory system. For updating the application, the memory system may determine a physical location storing a piece of data constituting the application based on the data attribute of the piece of data, which is delivered along with the data for updating the application. Herein, the procedure of transferring the data attribute from the network server into the memory system may be understood through the embodiment shown in FIG. 7.

According to an embodiment of the disclosure, a memory system may receive the data with the attribute of data from a host, and store data in a nonvolatile memory block based on the attribute of data without determining attribute of each piece of data, so that performance of a program operation in the memory system may be improved and a lifespan of the nonvolatile memory block may be extended.

In an embodiment of the disclosure, the memory system may determine a data attribute stored in the nonvolatile memory block on a physical location basis, associate the attribute of data with a logical address for the data, and share the attribute of data corresponding to the logical address with other electrical devices via a network, so as to improve operational efficiency of an electrical device which provides network-based or cloud-based application services.

In addition, an embodiment of the disclosure may apply a data attribute to an operation performed by an application without performing additional operations for determining the attribute of data in an electrical device in which the application is installed.

While the present teachings have been illustrated and described with respect to the specific embodiments, it will be apparent to those skilled in the art in light of the present disclosure that various changes and modifications may be made without departing from the spirit and scope of the disclosure as defined in the following claims.

What is claimed is:

1. A memory system comprising:
a memory device including a plurality memory blocks; and
a controller configured to determine a data attribute regarding a piece of data stored in a memory block among the plurality of memory blocks, associate the data attribute with a logical address for the piece of data, and transmit the data attribute associated with the logical address to an external device.

2. The memory system according to claim 1, wherein the data attribute is determined based on a frequency of accessing the piece of data during a set period after the piece of data is stored in the memory device, and
wherein the data attribute is determined as one of a hot attribute and a cold attribute.

3. The memory system according to claim 1, wherein the data attribute is determined based on a frequency of accessing the piece of data during a set period after an external command is inputted from the external device, and
wherein the data attribute is determined as one of a hot attribute and a cold attribute.

4. The memory system according to claim 1, wherein the controller is configured to count the number of read, write, and erase operations corresponding to the logical address and determine the data attribute based on the counted number.

5. The memory system according to claim 4, wherein the controller is configured to determine that the data attribute is hot when the counted number is greater than or equal to a reference value, and the data attribute is cold when the counted number is less than the reference value.

6. The memory system according to claim 1, wherein the controller is configured to receive a command for inquiring the data attribute associated with the logical address, from the external device, and transmit the data attribute in response to the command.

7. The memory system according to claim 1, wherein the controller is configured to generate a piece of meta data including the logical address from the external device, a physical address associated with the logical address, and an access count indicating the number of read, write, and erase operations performed with the logical address.

8. A memory system comprising:
a memory device including a plurality of memory blocks allocated based on a type of data attribute; and
a controller configured to store a piece of data in a memory block among the plurality of memory blocks based on a data attribute for the piece of data, when a command from an external device includes the piece of data, a logical address for the piece of data, and a data attribute for the piece of data.

9. The memory system according to claim 8, wherein the controller is configured to determine the data attribute and transmit the data attribute to the external device, when the command does not include the data attribute for the piece of data.

10. The memory system according to claim 9, wherein the controller is configured to determine the data attribute based on an access count indicating the number of read, write, and erase operations performed with the logical address.

11. The memory system according to claim 9, wherein the controller is configured to receive a command for inquiring the data attribute corresponding to the logical address, from the external device, and transmit, to the external device, the data attribute in response to the command

12. A method for operating a memory system, comprising:
receiving a program request, a piece of data, a logical address and a data attribute regarding the piece of data from an external device;
determining a physical location for storing the piece of data in a memory block allocated based on the data attribute in a memory device;
programming the piece of data in the physical location; and
associating the logical address with the physical location.

13. The method according to claim 12, further comprising:
receiving a command for inquiring the data attribute corresponding to the logical address, from the external device; and
transmitting, to the external device, the data attribute in response to the command.

14. The method according to claim 13, wherein the data attribute is determined based on a frequency of accessing the piece of data during a set period after the piece of data is stored in the memory device, and
wherein the data attribute is determined as one of a hot attribute and a cold attribute.

15. The method according to claim 13, wherein the data attribute is determined based on a frequency of accessing the piece of data during a set period after an external command is inputted from the external device, and
wherein the data attribute is determined as one of a hot attribute and a cold attribute.

16. The method according to claim 12, further comprising:
counting the number of read, write, and erase operations corresponding to the logical address; and
determining the data attribute based on the counted number.

17. The method according to claim 16, wherein the data attribute is hot when the counted number is greater than or equal to a reference value, and the data attribute is cold when the counted number is less than the reference value.

18. The method according to claim 16, further comprising:
generating a piece of meta data including the logical address inputted from the external device, a physical address associated with the logical address, and an access count indicating the number of read, write, and erase operations performed with the logical address.
